(19) United States
(12) Patent Application Publication
(10) Pub. No.: US 2025/0317806 A1
(43) Pub. Date: Oct. 9, 2025

(54) SYSTEMS AND METHODS FOR A CONGESTION BASED TRANSFER

(71) Applicant: Verizon Patent and Licensing Inc., Basking Ridge, NJ (US)

(72) Inventors: John ANTYPAS III, Pittsburg, CA (US); Xihong WANG, Morris Plains, NJ (US); Alexander FADEEV, Summit, NJ (US)

(73) Assignee: Verizon Patent and Licensing Inc., Basking Ridge, NJ (US)

(21) Appl. No.: 18/630,701

(22) Filed: Apr. 9, 2024

(51) Int. Cl. H04W 28/24; H04L 43/0882; H04W 24/02

(52) U.S. Cl. CPC H04W 28/24; H04L 43/0882; H04W 24/02

(57) ABSTRACT

In some implementations, a device may receive a request as to whether a task is able to be fulfilled while satisfying one or more conditions, wherein the task is associated with a user equipment (UE) in a wireless network. The device may determine, based on the request, a network congestion state at a location associated with the UE. The device may determine, based on the network congestion state, whether the task is able to be fulfilled while satisfying the one or more conditions. The device provides a response to the request.

### BACKGROUND

Communication systems are widely deployed to provide various telecommunication services such as telephony, video, data, messaging, and broadcasts. A network may include one or more network nodes that support communication for wireless communication devices.

### BRIEF DESCRIPTION OF THE DRAWINGS

FIG. 1 is a diagram of an example associated with predicting whether tasks are able to be fulfilled in wireless networks while satisfying conditions.

FIG. 2 is a diagram of an example associated with network parameters.

FIG. 3 is a diagram of an example environment in which systems and/or methods described herein may be implemented.

FIG. 4 is a diagram of example components of one or more devices of FIG. 3.

FIG. 5 is a flowchart of an example process associated with predicting whether tasks are able to be fulfilled in wireless networks while satisfying conditions.

### DETAILED DESCRIPTION OF EXAMPLE EMBODIMENTS

The following detailed description of example implementations refers to the accompanying drawings. The same reference numbers in different drawings may identify the same or similar elements.

A performance of a mobile network, such as a cellular network, may vary considerably over a period of time due to changing network conditions. For example, a performance of a mobile network may vary more than a performance of a local area network (LAN), even though the mobile network and the LAN may utilize similar protocols. A radio may be statistical in nature, thereby making a prediction of performance at a given location and time difficult. An application may be unaware of network performance at any given time and may operate under the assumption that the network performance is consistently acceptable such that the application can function. The application may make recommendations to users based on the assumption that the network performance is consistent. For example, the application may recommend a file download or initiate the file download, where the application may be unaware of current network congestion. As a result, certain recommendations and/or actions of the application may degrade an overall system performance.

In some implementations, a network congestion reporting (NCR) system may allow applications (e.g., user applications) to gain visibility into network performance at a given location and time without requiring applications to have a deep understanding of mobile networks. The NCR system may identify, given an identifier of a user equipment (UE), an expected instantaneous bandwidth for that location under optimal conditions. In some embodiments, the identifier may be an Internet Protocol (IP) address or a mobile station international subscriber directory number (MSISDN). The NCR system may identify, given the identifier and a desired optimal bandwidth, whether this bandwidth can be achieved at this particular time and/or location. When the bandwidth cannot be achieved, the NCR system may suggest a time during which the desired optimal bandwidth may be possible for that location. The NCR system may determine, given the identifier, a size of a data transfer, and a time window, whether the data transfer can successfully proceed, at a consistent performance level, within that time window. When the consistent performance level (in one embodiment, within various configured or dynamic threshold variations) cannot be achieved, the NCR system may suggest a time during which the consistent performance level may be possible for that location. A “consistent performance level” may refer to a data rate that does not vary outside of a threshold value and/or an absence of network congestion. Further, given a bulk data transfer, the NCR system may identify an expected completion time if possible. The NCR system return such information to the application, and the application may use such information when making recommendations or performing actions.

In some implementations, by configuring the NCR system to provide information on network performance at a given location and time, the application may use such information to perform actions while maximizing a system performance. Based on knowledge of the expected instantaneous bandwidth at a certain location and time, knowledge of whether the desired optimal bandwidth is possible at a certain location and time, knowledge on whether the data transfer is possible at the consistent performance level at a certain location and time, etc., the application may schedule and perform tasks accordingly to maximize the system performance. For example, based on information that a certain time is expected to be associated with poor bandwidth, the application may not schedule a relatively large file transfer at that time. As a result, an application and system performance may be improved.

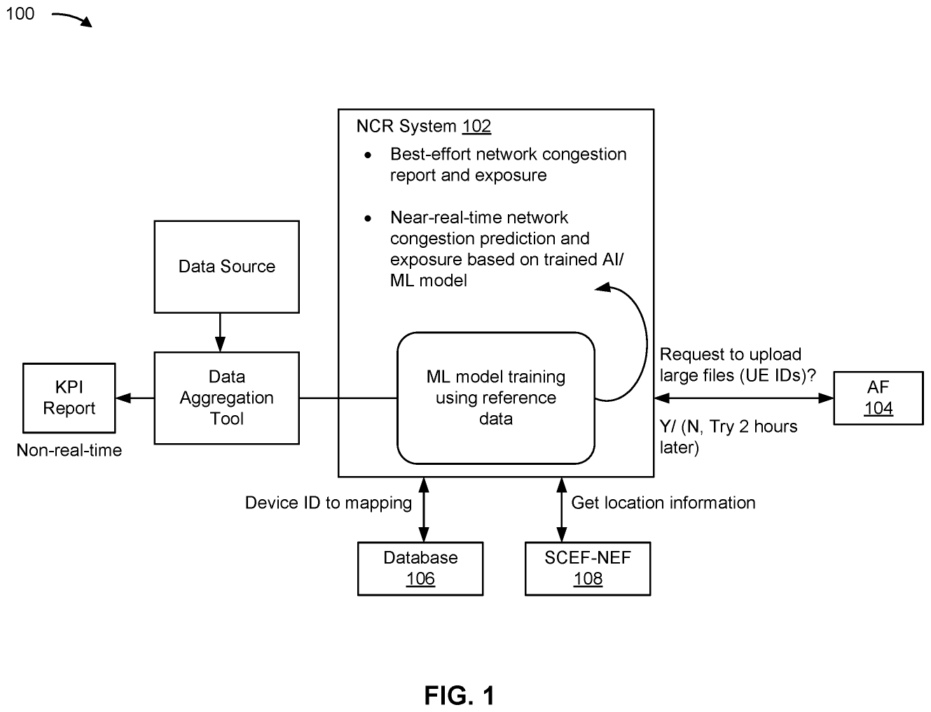

FIG. 1 is a diagram of an example 100 associated with predicting whether tasks are able to be fulfilled in wireless networks while satisfying conditions. As shown in FIG. 1, example 100 includes an NCR system 102, an application function (AF) 104, a database 106, and a service capability exposure function network exposure function (SCEF-NEF) 108.

In some implementations, the NCR system 102 may produce a best-effort network congestion report and exposure. The NCR system 102 may perform a near-real-time network congestion prediction and exposure based on a trained artificial intelligence and/or machine learning (AI/ML) model. The AI/ML model may be trained using reference data. The database 106 may be associated with a device ID mapping. The SCEF-NEF 108 may be associated with a location service. As an example, the AF 104 may query the NCR system 102 as to whether a current time is appropriate for uploading a relatively large file. The AF 104 may indicate an appropriate UE ID, which may allow the NCR 102 to determine congestion at a location associated with the UE ID. The NCR system 102 may return a response indicating that the current time is appropriate based on a lack of congestion at the location, or alternatively, the NCR system 102 may return a response indicating that the current time is not appropriate and instead to upload the file two hours later. Signaling between the NCR system 102 and the AF 104 may be transmitted via Hypertext Transfer Protocol Secure (HTTPS) or Mutual Transport Layer Security (mTLS).

In some implementations, as part of an IP address to MSISDN maping process, when a UE attaches or detaches to a network or when a port chunk range changes for IP version 4 (IPv4), a Fourth Generation (4G) packet data network gateway (PGW) or a Fifth Generation (5G) user plane function (UPF) may generate pilot packets and IP Flow Information Export (IPFIX) user datagram protocol (UDP) packets, respectively. Each packet may contain a device identifier (ID) such as an MSISDN, an allocated device IP address, and other UE session information. Such information may be stored in the database 106 in a mutually exclusive, collectively exhaustive (MECE) manner. When the AF 104 queries the device ID (e.g., MSISDN) with the allocated device IP address, the NCR system 102 may perform a lookup on the database 106 and return the device ID. When the device ID or the allocated device IP address is not in the database, an error code may be returned to the AF 104.

In some implementations, given an address or an MSISDN, the location service (e.g., via the SCEF-NEF 108) may return a coarse location of a UE. The location service may return the coarse location as a five-digit zip-code, at least in the US. Given an IP address and a port, the location service may identify an appropriate MSISDN via an IP Address to MSISDN service. After a cell site (the coarse location) is obtained, an almanac or other mapping service may be used to map that cell site to the zip code.

In some implementations, the NCR system 102 and the corresponding AI/ML model, when given an MSISDN, may obtain a connection congestion state of a location associated with the MSISDN. When the UE is outside of a compatible network, an appropriate message may be returned. Congestion data may be converted into a simple range (e.g., less than 25%, 25-50%, 50-75%, 75%-90%, or above 90%). The congestion data may indicate congestion at a current location. In some cases, the congestion data may indicate a future congestion prediction.

In some implementations, a radio access network (RAN) may generate system performance counters on a frequent basis. These counters may be stored in a central system and provide a data source. A data aggregation tool may be used to pull such performance data from the data source. The data source may be any network element or function (performance data source. As a specific example, the data source may be a RAN data source. The data aggregation tool may pull raw data, aggregate the raw data, and generate key performance indicators (KPIs). The NCR system 102 may retrieve selected KPIs from the data aggregation tool. The NCR system 102 may calculate network congestion states based on the selected KPIs. Based on predefined thresholds, the NCR system 102 may determine whether a network utilization is in a given performance range for that location, where location services may be used to determine the location of the cell site.

In some implementations, the NCR system 102 may satisfy various functions using such data and various formulas. The NCR system 102 may return, given an IP address or an MSISDN, an instantaneous bandwidth for that location. The NCR system 102 may determine, given an IP address or an MSISDN, and a bandwidth requirement, whether the location is able to support that bandwidth at this time, or the NCR system 102 may suggest an alternate time. The NCR system 102 may determine, given an IP address or an MSISDN, a bulk data size, and a time window, whether a network is able to support a bulk data transfer within that time window, or the NCR system 102 may suggest one or more alternate time windows for that location. The network may support the bulk data transfer when the network is able to provide the consistent performance level, and not necessarily whether a file transfer will be completed at that time.

In some implementations, the NCR system 102 may determine an instantaneous network bandwidth for a location given an IP address or an MSISDN. When presented with the IP address, the NCR system 102 may use an IP-to-MSISDN service to convert the IP address to an MSISDN. The NCR system 102 may compute a network bandwidth by taking a network throughput per cell divided by a number of users per cell. The NCR system 102 may return this computed value.

In some implementations, the NCR system 102 may determine when a desired instantaneous bandwidth is available at a given location, given an IP address or an MSISDN, and, if not, the NCR system 102 may return an alternate time window. The NCR system 102 may receive a desired bandwidth request, which may indicate the desired instantaneous bandwidth of the UE. The NCR system 102 may determine whether the desired bandwidth request is able to be satisfied (e.g., return YES). When the desired instantaneous bandwidth cannot be satisfied, the NCR system 102 may consult the AI/ML model to identify one or more time windows that satisfy a congestion requirement. When a match is found with an appropriate time window, the NCR system 102 may return an indication of the time window. Otherwise, the NCR system 102 may return that no match was found.

In some implementations, the NCR system 102 may determine whether a desired bulk data transfer can complete at a given time window, given an IP address or an MSISDN, a size of the desired bulk data transfer, and a start time window. Given the IP address or the MSISDN, the NCR system 102 may retrieve a bulk data size and a desired start time from the UE. The NCR system 102 may use the AI/ML model to identify a predicted bandwidth at a specified time window. At a start time (time 1) of the specified time window, the NCR system 102 may determine whether the predicted bandwidth meets performance criteria (or a performance level). The NCR system 102 may compute an end time (time 2) of the specified time window by taking the bulk data size divided by predicted bandwidth within that specified time window. The NCR system 102 may determine, using the AI/ML model, that both the start time and the end time meet performance criteria (e.g., return YES). Alternatively, the NCR system 102 may determine, using the AI/ML model, that either the start time or the end time does not meet the performance criteria (e.g., return NO), in which case the NCR system 102 may return a preferred time window.

In some implementations, given input parameters such as the IP address, the MSISDN, the size of transfer, and/or the start time window, the NCR system 102 may determine whether the desired bulk data transfer is able to be done under acceptable conditions. The NCR system 102 may return an estimated completion time, or the NCR system 102 may return a preferred time window. The NCR system 102 may compute the possibility of the desired bulk data transfer within a time window. The NCR system 102 may compute the end time of the desired bulk data transfer (e.g., return YES), which may correspond to the end time (time 2) of the specified time window. When a request to complete the desired bulk data transfer within the time window cannot be met, the NCR system 102 may return an alternative time.

In some implementations, the NCR system 102 may have an ability to use collected performance data to indicate instantaneous network resources that are available to an application. The NCR system 102 may use prediction formulas to advise a subscriber based on future bandwidth conditions. The NCR system 102 may have an ability to indicate whether such network resources are available within a time, date, and/or location window. The NCR system 102 may have an ability to use the AI/ML model to indicate when such network resources will be available within a resource, time, and/or location window, especially when those resources are not yet available. The NCR system 102 may present information to the user (e.g., return YES or NO) without actually requiring the UE to possess expansive knowledge of a cellular network. For example, for certain tasks, the NCR system 102 may simply indicate that the wireless network can comply with a specific task, or that the wireless network cannot comply at a certain time for the specific task but the wireless network may be able to comply at a given alternate time. The NCR system 102 may have an ability to return useful current network information to the subscriber. The NCR system 102 may have an ability to return future network information to the subscriber. The NCR system 102 may use a variety of network performance indicators to determine whether a suitable task can be completed. The NCR system 102 may be applicable to Internet of Things (IoT) platform uploads and/or downloads (e.g., software updates).

As indicated above, FIG. 1 is provided as an example. Other examples may differ from what is described with regard to FIG. 1. The number and arrangement of devices shown in FIG. 1 are provided as an example. In practice, there may be additional devices, fewer devices, different devices, or differently arranged devices than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) shown in FIG. 1 may perform one or more functions described as being performed by another set of devices shown in FIG. 1.

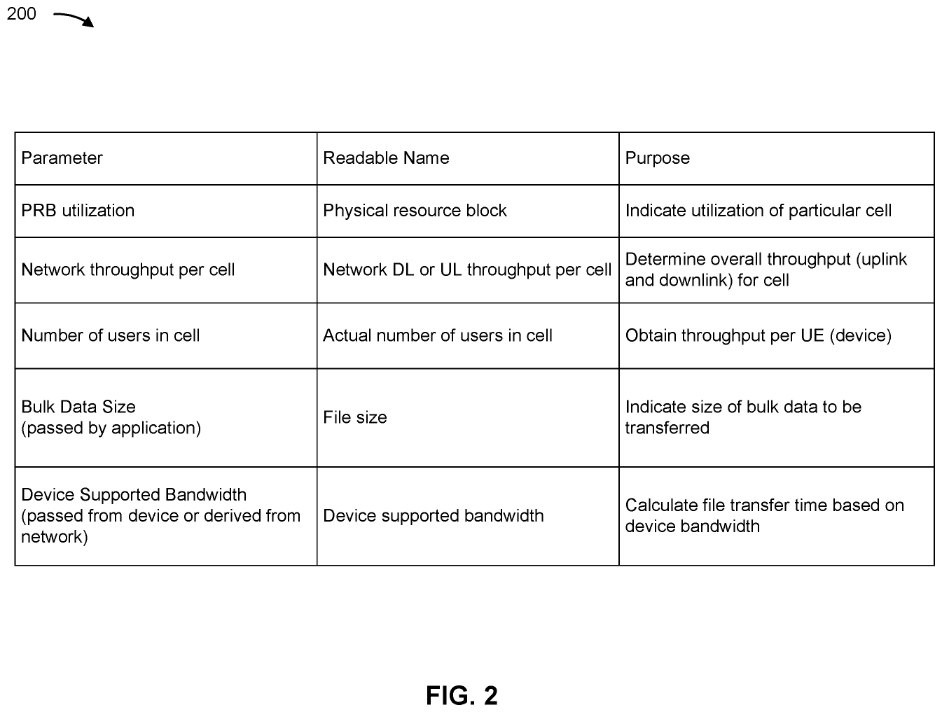

FIG. 2 is a diagram of an example 200 associated with network parameters.

As shown in FIG. 2, various network parameters may be used to support network congestion reporting. For example, the network parameters may include a physical resource block (PRB) utilization parameter, which may indicate a utilization of a particular cell. The network parameters may include a network downlink or uplink throughput per cell, which may indicate an overall throughput (uplink and downlink) for a cell. The network parameters may include a number of users in a cell, which may be used to obtain a throughput per UE (device). The network parameters may include a bulk data size or file size passed by an application, which may be used to indicate a size of bulk data to be transferred. The network parameters may include a device supported bandwidth (passed from the UE or derived from the network), which may be used to calculate a file transfer time.

As indicated above, FIG. 2 is provided as an example. Other examples may differ from what is described with regard to FIG. 2.

In some implementations, different use cases may be considered. In a first use case, an application may provide real-time voice over IP (VOIP) or video streaming, and the application may regularly need to move large files in the most efficient manner. The application may perform real-time activities such as live telemetry and bulk activities such as firmware updates. The application may start on a UE. As part of a startup process, the application may check whether any new updates are available. Such updates may not be critical to perform immediately. When updates are available, and the UE is idle, the application may request an application server to start an upgrade. After a protocol exchange, the application server may determine a file size of the upgrade and a device IP or an MSISDN associated with the UE. The application server may contact an NCR system. For example, the application server may indicate that a certain number of gigabytes (GBs) is needed to transfer data to the UE within a next amount of time, and the application server may request whether such a data transfer is possible. The NCR system may determine, using an AI/ML model, whether the request is able to be satisfied. When the request is able to be satisfied, the NCR system may notify the application server (e.g., return YES). Otherwise, when the request is not able to be satisfied, the NCR system may notify the application server (e.g., return NO). The NCR system may identify an alternative time at which the data transfer is possible (e.g., 8:30 pm), and the NCR system may indicate the alternative time to the application server. An actual message format may be specific to the application.

In the first use case, after the request is determined to be satisfied or not satisfied, the application may later request the application server to stream a particular video in a 1080p resolution. The request may be to stream the particular video at a current time, which may require a specific amount of bandwidth. The application server may contact the NCR system. For example, the application server may request whether the particular video is able to be currently streamed given the specific amount of bandwidth needed. When the request is able to be satisfied, the NCR system may notify the application server (e.g., return YES). Otherwise, when the request is not able to be satisfied, the NCR system may notify the application server (e.g., return NO). The NCR system may identify an alternative time at which the particular video can be streamed at the specific amount of bandwidth needed. In some implementations, the NCR system may not enforce a suggestion provided to the application server. The application server may determine to continue with an action (e.g., a file transfer or video streaming) at a given time, even when the action is not recommended by the NCR system at the given time.

In a second use case, a public safety organization may use body cameras. Body cameras may have limited storage and battery power, and body cameras are not always within WiFi range. In this case, a body camera user may finish work for the day and may need to upload footage. The body camera may contact an application server. The body camera may pass its ID, or the application server may use a calling IP address to automatically obtain an MSISDN associated with the body camera. The application server may contact the NCR system. For example, the application server may request whether a certain number of GBs of data is able to be uploaded within a next amount of time. The NCR system may determine, using an AI/ML model, whether the application server should initiate a transfer of footage at a given time. When the request is able to be satisfied, the NCR system may notify the application server (e.g., return YES). Otherwise, when the request is not able to be satisfied, the NCR system may notify the application server (e.g., return NO). The NCR system may identify an alternative time at which the footage can be uploaded. The application server may prevent the footage from being uploaded based on the notification from the NCR system. In this case, the application server may provide a suggestion that the transfer should be performed at a new proposed time. Alternatively, the application server may disregard the notification from the NCR system and allow the transfer to be performed at the given time.

In a third use case, an IoT device may periodically receive software updates from an application server. The application server may contact the NCR system. For example, the application server may request whether a software update associated with a certain amount of data is able to be downloaded by the IoT device within a next amount of time. The NCR system may determine, using an AI/ML model, whether the application server should initiate a downlink transfer of the software update at a given time. When the request is able to be satisfied, the NCR system may notify the application server (e.g., return YES). Otherwise, when the request is not able to be satisfied, the NCR system may notify the application server (e.g., return NO).

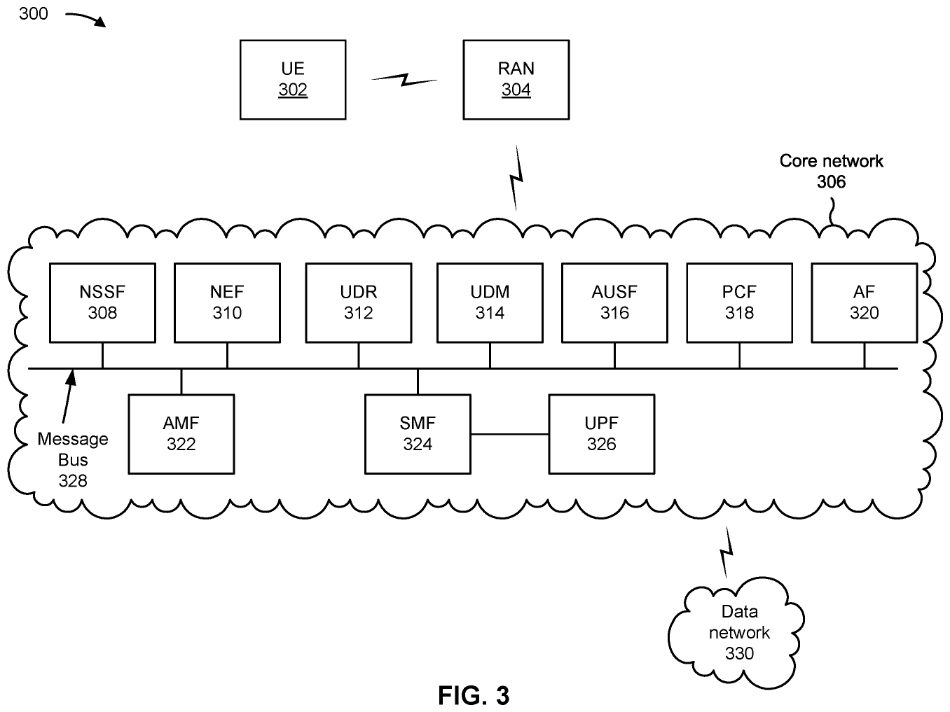

FIG. 3 is a diagram of an example environment 300 in which systems and/or methods described herein may be implemented. As shown in FIG. 3, example environment 300 may include a UE 302, a RAN 304, a core network 306, and a data network 330. Devices and/or networks of example environment 300 may interconnect via wired connections, wireless connections, or a combination of wired and wireless connections.

The UE 302 may include one or more devices capable of receiving, generating, storing, processing, and/or providing information, such as information described herein. For example, the UE 302 can include a mobile phone (e.g., a smart phone or a radiotelephone), a laptop computer, a tablet computer, a desktop computer, a handheld computer, a gaming device, a wearable communication device (e.g., a smart watch or a pair of smart glasses), a mobile hotspot device, a fixed wireless access device, customer premises equipment, an autonomous vehicle, or a similar type of device.

The RAN 304 may support, for example, a cellular radio access technology (RAT). The RAN 304 may include one or more base stations (e.g., base transceiver stations, radio base stations, node Bs, eNodeBs (eNBs), gNodeBs (gNBs), base station subsystems, cellular sites, cellular towers, access points, transmit receive points (TRPs), radio access nodes, macrocell base stations, microcell base stations, picocell base stations, femtocell base stations, or similar types of devices) and other network entities that can support wireless communication for the UE 302. A base station may be a disaggregated base station. The disaggregated base station may be configured to utilize a protocol stack that is physically or logically distributed among two or more nodes, which may include a radio unit (RU), a distributed unit (DU), and a centralized unit (CU). The RAN 304 may transfer traffic between the UE 302 (e.g., using a cellular RAT), one or more base stations (e.g., using a wireless interface or a backhaul interface, such as a wired backhaul interface), and/or the core network 306. The RAN 304 may provide one or more cells that cover geographic areas.

In some implementations, the RAN 304 may perform scheduling and/or resource management for the UE 302 covered by the RAN 304 (e.g., the UE 302 covered by a cell provided by the RAN 304). In some implementations, the RAN 304 may be controlled or coordinated by a network controller, which may perform load balancing, network-level configuration, and/or other operations. The network controller may communicate with the RAN 304 via a wireless or wireline backhaul. In some implementations, the RAN 304 may include a network controller, a self-organizing network (SON) module or component, or a similar module or component. In other words, the RAN 304 may perform network control, scheduling, and/or network management functions (e.g., for uplink, downlink, and/or sidelink communications of the UE 302 covered by the RAN 304).

In some implementations, the core network 306 may include an example functional architecture in which systems and/or methods described herein may be implemented. For example, the core network 306 may include an example architecture of a 5G next generation (NG) core network included in a 5G wireless telecommunications system. While the example architecture of the core network 306 shown in FIG. 3 may be an example of a service-based architecture, in some implementations, the core network 306 may be implemented as a reference-point architecture and/or a 3G core network, among other examples.

As shown in FIG. 3, the core network 306 may include a number of functional elements. The functional elements may include, for example, a network slice selection function (NSSF) 308, a network exposure function (NEF) 310, a unified data repository (UDR) 312, a unified data management (UDM) 314, an authentication server function (AUSF) 316, a policy control function (PCF) 318, an AF 320, an access and mobility management function (AMF) 322, a session management function (SMF) 324, and/or a UPF 326. These functional elements may be communicatively connected via a message bus 328. Each of the functional elements shown in FIG. 3 is implemented on one or more devices associated with a wireless telecommunications system. In some implementations, one or more of the functional elements may be implemented on physical devices, such as an access point, a base station, and/or a gateway. In some implementations, one or more of the functional elements may be implemented on a computing device of a cloud computing environment.

The NSSF 308 may include one or more devices that select network slice instances for the UE 302. The NSSF 308 may allow an operator to deploy multiple substantially independent end-to-end networks potentially with the same infrastructure. In some implementations, each slice may be customized for different services. The NEF 310 may include one or more devices that support exposure of capabilities and/or events in the wireless telecommunications system to help other entities in the wireless telecommunications system discover network services.

The UDR 312 may include one or more devices that provide a converged repository, which may be used by network functions to store data. For example, a converged repository of subscriber information may be used to service a number of network functions. The UDM 314 may include one or more devices to store user data and profiles in the wireless telecommunications system. The UDM 314 may generate authentication vectors, perform user identification handling, perform subscription management, and perform other various functions. The AUSF 316 may include one or more devices that act as an authentication server and support the process of authenticating the UE 302 in the wireless telecommunications system.

The PCF 318 may include one or more devices that provide a policy framework that incorporates network slicing, roaming, packet processing, and/or mobility management, among other examples. The AF 320 may include one or more devices that support application influence on traffic routing, access to the NEF 310, and/or policy control, among other examples. The AMF 322 may include one or more devices that act as a termination point for non-access stratum (NAS) signaling and/or mobility management, among other examples. The SMF 324 may include one or more devices that support the establishment, modification, and release of communication sessions in the wireless telecommunications system. For example, the SMF 324 may configure traffic steering policies at the UPF 326 and/or may enforce UE internet protocol (IP) address allocation and policies, among other examples. The UPF 326 may include one or more devices that serve as an anchor point for intra-RAT and/or inter-RAT mobility. The UPF 326 may apply rules to packets, such as rules pertaining to packet routing, traffic reporting, and/or handling user plane QoS, among other examples. The message bus 328 may represent a communication structure for communication among the functional elements. In other words, the message bus 328 may permit communication between two or more functional elements.

The data network 330 may include one or more wired and/or wireless data networks. For example, the data network 330 may include an Internet Protocol multimedia subsystem (IMS), a public land mobile network (PLMN), a LAN, a wide area network (WAN), a metropolitan area network (MAN), a private network such as a corporate intranet, an ad hoc network, the Internet, a fiber optic-based network, a cloud computing network, a third party services network, an operator services network, and/or a combination of these or other types of networks.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of example environment 300 may perform one or more functions described as being performed by another set of devices of example environment 300.

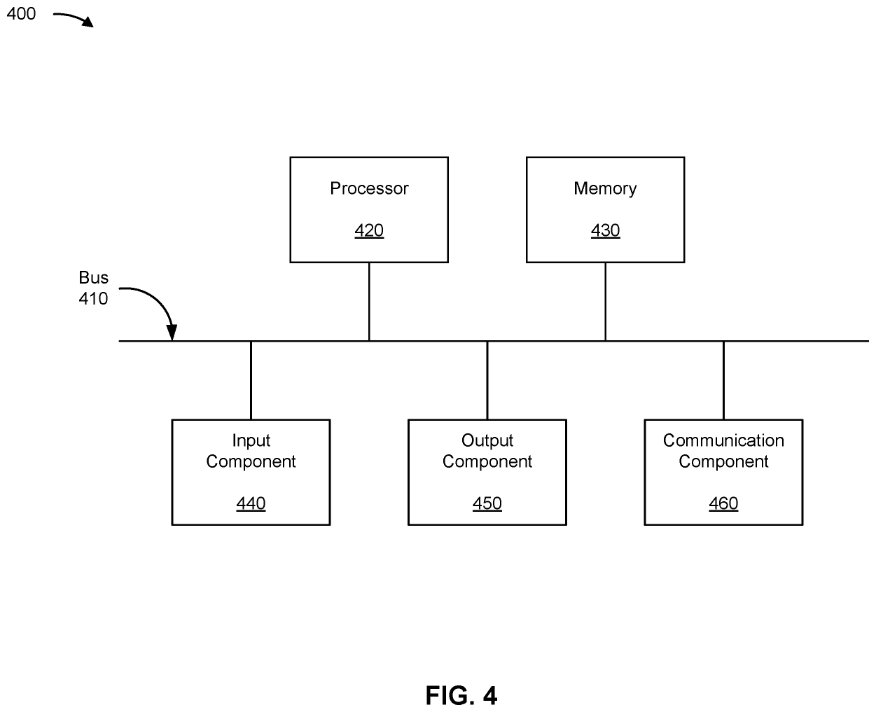

FIG. 4 is a diagram of example components of a device 400 associated with predicting whether tasks are able to be fulfilled in wireless networks while satisfying conditions. The device 400 may correspond to an NCR system (e.g., NCR system 102). In some implementations, the network device may include one or more devices 400 and/or one or more components of the device 400. As shown in FIG. 4, the device 400 may include a bus 410, a processor 420, a memory 430, an input component 440, an output component 450, and/or a communication component 460.

The bus 410 may include one or more components that enable wired and/or wireless communication among the components of the device 400. The bus 410 may couple together two or more components of FIG. 4, such as via operative coupling, communicative coupling, electronic coupling, and/or electric coupling. For example, the bus 410 may include an electrical connection (e.g., a wire, a trace, and/or a lead) and/or a wireless bus. The processor 420 may include a central processing unit, a graphics processing unit, a microprocessor, a controller, a microcontroller, a digital signal processor, a field-programmable gate array, an application-specific integrated circuit, and/or another type of processing component. The processor 420 may be implemented in hardware, firmware, or a combination of hardware and software. In some implementations, the processor 420 may include one or more processors capable of being programmed to perform one or more operations or processes described elsewhere herein.

The memory 430 may include volatile and/or nonvolatile memory. For example, the memory 430 may include random access memory (RAM), read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection). The memory 430 may be a non-transitory computer-readable medium. The memory 430 may store information, one or more instructions, and/or software (e.g., one or more software applications) related to the operation of the device 400. In some implementations, the memory 430 may include one or more memories that are coupled (e.g., communicatively coupled) to one or more processors (e.g., processor 420), such as via the bus 410. Communicative coupling between a processor 420 and a memory 430 may enable the processor 420 to read and/or process information stored in the memory 430 and/or to store information in the memory 430.

The input component 440 may enable the device 400 to receive input, such as user input and/or sensed input. For example, the input component 440 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 450 may enable the device 400 to provide output, such as via a display, a speaker, and/or a light-emitting diode. The communication component 460 may enable the device 400 to communicate with other devices via a wired connection and/or a wireless connection. For example, the communication component 460 may include a receiver, a transmitter, a transceiver, a modem, a network interface card, and/or an antenna.

The device 400 may perform one or more operations or processes described herein. For example, a non-transitory computer-readable medium (e.g., memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry may be used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

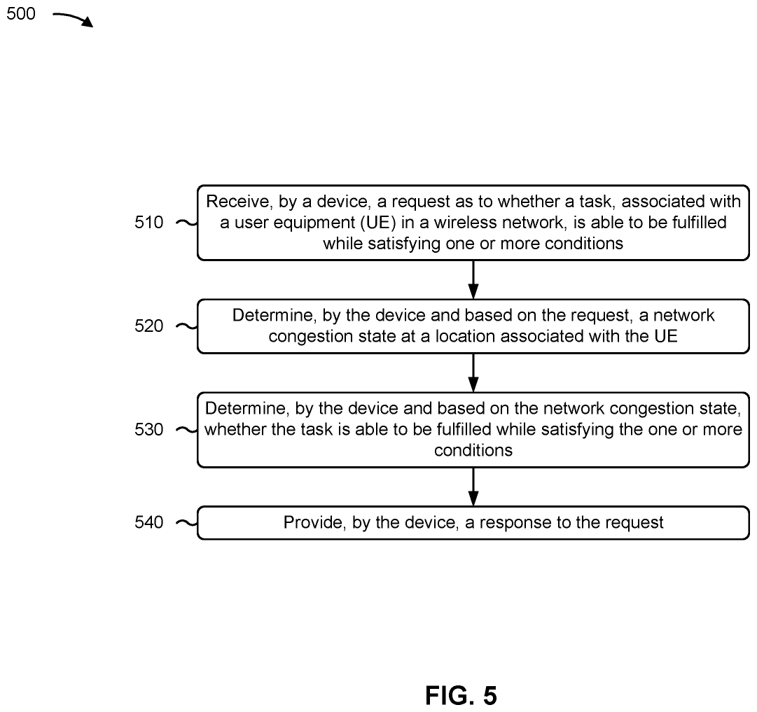

FIG. 5 is a flowchart of an example process 500 associated with predicting whether tasks are able to be fulfilled in wireless networks while satisfying conditions. In some implementations, one or more process blocks of FIG. 5 may be performed by an NCR system (e.g., NCR system 102). In some implementations, one or more process blocks of FIG. 5 may be performed by another entity or a group of entities separate from or including the NCR system. Additionally, or alternatively, one or more process blocks of FIG. 5 may be performed by one or more components of device 400, such as processor 420, memory 430, input component 440, output component 450, and/or communication component 460.

As shown in FIG. 5, process 500 may include receiving, by the device, a request as to whether a task is able to be fulfilled while satisfying one or more conditions, wherein the task is associated with a user equipment (UE) in a wireless network (block 510). The request may indicate an IP address associated with the UE or an MSISDN associated with the UE. As an example, the task may be associated with a file transfer from an application server to the UE, and the one or more conditions may be associated with a size of the file transfer and a desired amount of time for completing the file transfer. As another example, the task may be associated with a video streaming from a server to the UE, and the one or more conditions may be associated with a desired video resolution.

As shown in FIG. 5, process 500 may include determining, by the device and based on the request, a network congestion state at a location associated with the UE (block 520). The network congestion state may be associated with the IP address or the MSISDN. In other words, the device may determine the IP address or the MSISDN associated with the UE. The device may determine the location associated with the IP address or the MSISDN. The device may then determine the network congestion state at the location. The device may determine the network congestion state using data collected in a RAN.

As shown in FIG. 5, process 500 may include determining, by the device and based on the network congestion state, whether the task is able to be fulfilled while satisfying the one or more conditions (block 530). The device may provide an indication of the request, the one or more conditions, and the network congestion state to an AI/ML model. The device may determine whether the task is able to be fulfilled while satisfying the one or more conditions based on an output of the AI/ML model.

As shown in FIG. 5, process 500 may include providing, by the device, a response to the request (block 540). The response may indicate that the task is able to be fulfilled while satisfying the one or more conditions. Alternatively, the response may indicate that the task is not able to be fulfilled while satisfying the one or more conditions. In this case, the response may indicate an alternate time at which the task is expected to be fulfilled while satisfying the one or more conditions.

In some implementations, the device may determine an instantaneous network bandwidth at the location based on a network throughput in a cell and a number of UEs in the cell. The response may include an indication of the instantaneous network bandwidth. In some implementations, the one or more conditions may include a desired instantaneous bandwidth. The device, when determining whether the task is able to be fulfilled while satisfying the one or more conditions, may determine that the desired instantaneous bandwidth is available at the location. The response may include an indication that the desired instantaneous bandwidth is available.

In some implementations, the one or more conditions may include a desired instantaneous bandwidth. The device, when determining whether the task is able to be fulfilled while satisfying the one or more conditions, may determine that the desired instantaneous bandwidth is not available at the location. The device may determine an alternate time window during which the desired instantaneous bandwidth is expected to be available at the location. The response may include an indication of the alternate time window.

In some implementations, the task may be a data transfer and the one or more conditions may include a desired data transfer time given a data transfer size and a start time. The device, when determining whether the data transfer is able to be fulfilled while satisfying the one or more conditions, may determine that a bandwidth at the location satisfies a threshold. The device may determine an expected end time for the data transfer based on an expected bandwidth at the location during a time window associated with the data transfer. The device may determine whether the desired data transfer time is expected to be satisfied based on the start time and the expected end time. The response may include an indication as to whether the desired data transfer time is expected to be satisfied. In some cases, the desired data transfer time may not be expected to be satisfied. In this case, the device may determine one or more preferred time windows during which the desired data transfer time is expected to be satisfied. The response may include an indication of the preferred time window(s).

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, by a device, a request as to whether a task is able to be fulfilled while satisfying one or more conditions, wherein the task is associated with a user equipment (UE) in a wireless network;
determining, by the device and based on the request, a network congestion state at a location associated with the UE;
determining, by the device and based on the network congestion state, whether the task is able to be fulfilled while satisfying the one or more conditions; and
providing, by the device, a response to the request.

2. The method of claim 1, wherein the request indicates an identifier associated with the UE, and the network congestion state is associated with the identifier.

3. The method of claim 1, further comprising:
determining, by the device, an instantaneous network bandwidth at the location based on a network throughput in a cell and a number of UEs in the cell, wherein the response includes an indication of the instantaneous network bandwidth.

4. The method of claim 1, wherein the one or more conditions includes a desired instantaneous bandwidth, and determining whether the task is able to be fulfilled while satisfying the one or more conditions further comprises:
determining, by the device, that the desired instantaneous bandwidth is available at the location, wherein the response includes an indication that the desired instantaneous bandwidth is available.

5. The method of claim 1, wherein the one or more conditions includes a desired instantaneous bandwidth, and determining whether the task is able to be fulfilled while satisfying the one or more conditions further comprises:
determining, by the device, that the desired instantaneous bandwidth is not available at the location; and
determining, by the device, one or more alternate time windows during which the desired instantaneous bandwidth is expected to be available at the location, wherein the response includes an indication of the alternate time window.

6. The method of claim 1, wherein the task is a data transfer and the one or more conditions includes a desired data transfer time given a data transfer size and a start time, and determining whether the data transfer is able to be fulfilled while satisfying the one or more conditions further comprises:
determining, by the device, that a bandwidth at the location satisfies a threshold;
determining, by the device, an expected end time for the data transfer based on an expected bandwidth at the location during a time window associated with the data transfer; and
determining, by the device, whether the desired data transfer time is expected to be satisfied based on the start time and the expected end time, wherein the response includes an indication as to whether the desired data transfer time is expected to be satisfied.

7. The method of claim 6, wherein the desired data transfer time is not expected to be satisfied, and further comprising:
determining, by the device, a preferred time window during which the desired data transfer time is expected to be satisfied, wherein the response includes an indication of the preferred time window.

8. The method of claim 1, further comprising:
providing, by the device, an indication of the request, the one or more conditions, and the network congestion state to an artificial intelligence or machine learning (AI/ML) model, wherein a determination as to whether the task is able to be fulfilled while satisfying the one or more conditions is based on an output of the AI/ML model.

9. The method of claim 1, wherein the task is associated with a file transfer from an application server to the UE, and the one or more conditions are associated with a size of the file transfer and a desired amount of time for completing the file transfer.

10. The method of claim 1, wherein the task is associated with a video streaming from a server to the UE, and the one or more conditions are associated with a desired video resolution.

11. A device, comprising:
one or more processors configured to:
receive a request as to whether a task is able to be fulfilled for a user equipment (UE) while satisfying one or more conditions;
determine, based on the request, a network congestion state at a location associated with the UE;
determine, based on the network congestion state, whether the task is able to be fulfilled while satisfying the one or more conditions; and
provide a response to the request.

12. The device of claim 11, wherein the request indicates an Internet Protocol (IP) address associated with the UE or a mobile station international subscriber directory number (MSISDN) associated with the UE, and the network congestion state is associated with the IP address or the MSISDN.

13. The device of claim 11, wherein the one or more processors are configured to:
determine an instantaneous network bandwidth at the location based on a network throughput in a cell and a number of UEs in the cell, wherein the response includes an indication of the instantaneous network bandwidth.

14. The device of claim 11, wherein the one or more conditions includes a desired instantaneous bandwidth, and the one or more processors, to determine whether the task is able to be fulfilled while satisfying the one or more conditions, are configured to:
determine that the desired instantaneous bandwidth is available at the location, wherein the response includes an indication that the desired instantaneous bandwidth is available.

15. The device of claim 11, wherein the one or more conditions includes a desired instantaneous bandwidth, and the one or more processors, to determine whether the task is able to be fulfilled while satisfying the one or more conditions, are configured to:
determine that the desired instantaneous bandwidth is not available at the location; and
determine an alternate time window during which the desired instantaneous bandwidth is expected to be available at the location, wherein the response includes an indication of the alternate time window.

16. The device of claim 11, wherein the task is a data transfer and the one or more conditions includes a desired data transfer time given a data transfer size and a start time, and the one or more processors, to determine whether the task is able to be fulfilled while satisfying the one or more conditions, are configured to:
determine that a bandwidth at the location satisfies a threshold;
determine an expected end time for the data transfer based on an expected bandwidth at the location during a time window associated with the data transfer; and
determine whether the desired data transfer time is expected to be satisfied based on the start time and the expected end time, wherein the response includes an indication as to whether the desired data transfer time is expected to be satisfied.

17. The device of claim 16, wherein the desired data transfer time is not expected to be satisfied, and the one or more processors are configured to:
determine a preferred time window during which the desired data transfer time is expected to be satisfied, wherein the response includes an indication of the preferred time window.

18. The device of claim 11, wherein the one or more processors are configured to:
provide an indication of the request, the one or more conditions, and the network congestion state to an artificial intelligence or machine learning (AI/ML) model, wherein a determination as to whether the task is able to be fulfilled while satisfying the one or more conditions is based on an output of the AI/ML model.

19. The device of claim 11, wherein:
the task is associated with a file transfer from an application server to the UE, and the one or more conditions are associated with a size of the file transfer and a desired amount of time for completing the file transfer; or
the task is associated with a video streaming from a server to the UE, and the one or more conditions are associated with a desired video resolution.

20. A non-transitory computer-readable medium storing a set of instructions, the set of instructions comprising:
one or more instructions that, when executed by one or more processors of a device, cause the device to:
receive a request as to whether a task is able to be fulfilled by a wireless network for a user equipment (UE) while satisfying one or more conditions;
determine, based on the request, a network congestion state at a location associated with the UE;
determine, based on the network congestion state, whether the task is able to be fulfilled while satisfying the one or more conditions; and
provide a response to the request.
